(19) United States
(12) Patent Application Publication
(10) Pub. No.: US 2018/0060970 A1
(43) Pub. Date: Mar. 1, 2018

(54) SYSTEM AND METHOD FOR CONTEXT-BASED DRIVER MONITORING

(71) Applicant: International Business Machines Corporation, Armonk, NY (US)

(72) Inventors: ERICK NELSON ODUOR, Nairobi (KE); SAMUEL OMONDI, Nairobi (KE); MICHIAKI TATSUBORI, Nairobi (KE); AISHA WALCOTT, Nairobi (KE); JOHN MBARI WAMBURU, Nairobi (KE)

(21) Appl. No.: 15/430,212

(22) Filed: Feb. 10, 2017

(30) Foreign Application Priority Data
Sep. 1, 2016 (KE) KE/P/2016/2551

(51) Int. Cl. G06Q 40/08; G01C 21/34; B60W 40/09

(52) U.S. Cl. CPC G06Q 40/08; G01C 21/34; B60W 2530/14; B60W 2540/30; B60W 2550/14; B60W 40/09

(57) ABSTRACT

The disclosure provides electronic systems and methods for monitoring and improving driver behaviour. Driver maneuver data is obtained and used along with contextual data in order to determine enhanced estimates of driver and route riskiness. The output of the determination can be used by a variety of users including insurance providers.

### CROSS-REFERENCE TO RELATED APPLICATIONS

This application claims foreign priority to Kenyan Application KE/P/2016/2551 filed Sep. 1, 2016, the complete disclosure of which is expressly incorporated herein by reference in its entirety for all purposes.

### FIELD OF THE INVENTION

In embodiments, the technical field of the invention is electronic systems and methods for monitoring and improving driver behaviour.

### BACKGROUND

Usage-based insurance is widely used in the transportation industry, but is sub-optimally administered due to a lack of relevant information and an inability to sufficiently incorporate available information, among other reasons. Determination of coverage and premiums for vehicle insurance may not incorporate driving context such as the conditions in which a driver is driving, driver skills and habits, and so on. Furthermore, the insurance packages offered to drivers by the insurance industry tend to be relatively homogeneous, even though driving skills and driving environments vary widely.

Typically, insurance includes two types of coverage: private and commercial policies. Packages are regulated at valuation of the vehicle and may not account for driver behaviour.

In developing countries, policyholders and vehicle owners may not be the nominal drivers of insured vehicles. Furthermore, roadways are dynamic with numerous modes of transport requiring vehicles to execute maneuvers to avoid hazards such as pedestrians, motorbikes, and pushcarts. All of these factors result in situations where policies and premiums are determined by factors that do not properly indicate the risk associated with the insurance policy.

### SUMMARY OF THE INVENTION

A goal of this invention is to provide a system to learn and detect the conditions and driving context that resulted in drivers executing dangerous maneuvers. Using contextual information, driver performance and behaviours can be determined and evaluated. Driver incident scores, which are widely used in the insurance industry but are typically crudely determined, are calculated using driver behaviour weighted within driving context to better predict risk associated with individual drivers. Driver risk patterns are determined relative to other's performance within similar context. Accordingly, the invention uses a cognitive method to reason across multiple domains, such as driver behavior, road quality, and traffic conditions- to understand drivers in any given context. Furthermore, the systems are able to gather insights for decision support on how to drive in specific parts of roads and in certain conditions/context (e.g., time of day, weather, etc.).

The usage-based automotive insurance industry, among others, is empowered by the methods and systems herein with an ability to reward drivers behaving well. This further encourages improved driver behaviour. In embodiments, the systems can be used for gamification to improve drivers' driving and to reduce risk. Accordingly, the systems offer an aid for behavioural change and enforcement to ultimately reduce the number of traffic-related accidents and fatalities. The systems also aid insurance companies to offer custom insurance packages (for drivers and owners), evaluate historical driver behaviour, and predict new driver risk based in part on contextual data. The invention may allow insurance providers to expand their customer base beyond vehicle owners to include drivers (where owners and drivers are different people/entities).

The systems may further reduce the number of claims by encouraging improved driver behavior through recommendations over how to drive in certain contexts. The systems may further provide input to routing system for minimal risk given current driving context. The systems may further auto-manufactures and producers of after market driver assistance devices/systems provide intelligent vehicle systems built to account for driving context as well as traditional measures of risk. The systems may further aid road planning, maintenance and decision support for government to update roads that would improve overall driving conditions.

In an aspect, then, is a method for determining driver behavior comprising: recording, by an in-vehicle sensor, a subject driver maneuver data and tagging the subject driver maneuver data with subject metadata comprising a subject time stamp and subject location stamp; retrieving from a driver maneuver database relevant historical driver maneuver data, the relevant historical driver maneuver data comprising tagged historical metadata comprising a historical location stamp that corresponds within a threshold distance to the subject location stamp; calculating a single-incident driver score by scaling the subject driver maneuver data according to the relevant historical driver maneuver data and tagged historical metadata; updating an aggregate subject driver score based on the single-incident driver score; and establishing a communication link with an automated insurance premium system and communicating the updated aggregate subject driver score to the automated insurance premium system. In embodiments:

the subject time stamp is provided by an in-vehicle clock or a GPS signal, and wherein the subject location stamp is provided by a GPS signal or determined from a plurality of cellular signals;

the subject maneuver data is determined from a plurality of in-vehicle sensors;

the historical metadata further comprises contextual information selected from weather, time of day, and season;

the updated aggregate subject driver score is in a message configured to cause the automated insurance premium system to automatically alter an insurance product based on the updated subject driver score;

the driver maneuver database is stored and maintained remotely on a remote server, wherein the remote server is configured to receive subject driver maneuver data and subject metadata;

further comprising updating the driver maneuver database based on the subject driver maneuver data and subject metadata;

the tagged historical metadata further comprises a historical weather report, and wherein the method further comprises obtaining a subject weather report corresponding to the subject location stamp and adding the subject weather report to the subject metadata; and

further comprising adding a subject weather report to the subject metadata, the subject weather report corresponding within a threshold distance to the subject time stamp and subject location stamp, and further comprising using the subject weather report in calculating the single-incident driver score.

In an aspect is a system that determines and monitors driver behavior comprising: an in-vehicle device configured to obtain subject driver maneuver data by selectively polling at least one in-vehicle sensor at a predetermined interval or upon a maneuver event, wherein the subject driver maneuver data is tagged with metadata comprising a subject location stamp and a subject time stamp; a processor coupled to a memory and a wireless network and configured to store the subject driver maneuver data in the memory along with relationship data that links the subject driver maneuver data to a vehicle identifier; a wireless transceiver configured to transmit the relationship data and subject driver maneuver data through a mobile communication network that provides access to a distributed network; a receiver configured to receive the relationship data and the subject driver maneuver data via the distributed network; and a processor coupled to the receiver and programmed to calculate a single-incident driver score by scaling the subject driver maneuver data according to relevant historical driver maneuver data and historical metadata corresponding to the relevant historical driver maneuver data, the relevant historical driver maneuver data correlating to the subject location, wherein the processor is further programmed to update an aggregate subject driver score based on the calculated single-incident driver score, and wherein the processor is further programmed to generate and transmit across the distributed network an alert based on the single-incident driver score or the aggregate subject driver score. In embodiments:

the wireless transceiver comprises a single-chip cellular baseband processor, where the single-chip cellular baseband processor comprises integrated interface drivers that enable auxiliary components comprising loudspeakers, display, and memory modules to connect directly to the single-chip;

the relevant historical driver maneuver data is obtained from a driver maneuver database comprising historical driver maneuver data and tagged historical metadata, the historical metadata comprising a time stamp and a location stamp;

the single-incident driver score is further determined by relevant road hazards, the relevant road hazards determined by receiving, by the processor, road hazard locations from a road hazard map, and correlating the location of road hazards to the subject location;

the alert is configured to cause one or more actions selected from: an insurance system on the distributed network to update an insurance premium for the driver; a route recommendation system to alter a route recommendation; a route recommendation system to determine a route least likely to impact a driver score; and a road maintenance authority to initiate a needed road repair at the subject location;

the processor is further configured to obtain a context data pertaining to the subject driver maneuver data and use the context data in calculating the single-incident driver score;

the relevant historical driver maneuver data is contained within a driver maneuver database coupled to the processor; and

the relevant historical driver maneuver data is contained within a driver maneuver database coupled to the processor, and wherein the processor is further configured to update the driver maneuver database based on the calculated single-incident driver score.

In an aspect is a method for determining and monitoring driver behavior comprising: obtaining, via an in-vehicle device, subject driver maneuver data by selectively polling at least one in-vehicle sensor at a predetermined interval or upon a maneuver event, wherein the subject driver maneuver data is tagged with metadata comprising a subject location stamp and a subject time stamp; storing, via a processor, the subject driver maneuver data and relationship data in an in-vehicle memory, wherein the relationship data links the subject driver maneuver data to a vehicle identifier and a wireless network; transmitting, via a wireless transceiver, the relationship data and subject driver maneuver data through a mobile communication network that provides access to a distributed network; receiving, via a receiver, the relationship data and the subject driver maneuver data via the distributed network; calculating, via a processor coupled to the receiver, a single-incident driver score by scaling the subject driver maneuver data according to relevant historical driver maneuver data, wherein the relevant historical driver maneuver data is selected from a driver maneuver database and correlates to the subject location, and wherein the processor is further programmed to update an aggregate subject driver score based on the single-incident driver score; and generating and transmitting across the distributed network an alert based on the single-incident driver score or the aggregate subject driver score.

In an aspect is a system comprising: a processor; and a memory coupled to the processor, the memory configured to store program instructions for instructing the processor to carry out the methods as above.

These and other aspects of the invention will be apparent to one of skill in the art from the description provided herein, including the examples and claims.

### BRIEF DESCRIPTION OF THE DRAWINGS

FIG. 1 provides a flow chart for collecting data and transmitting an alert to a recipient according to an aspect of the invention.

FIG. 2 provides a flow chart for collecting data and determining a context-based driver score according to an aspect of the invention.

FIG. 3 provides a flow chart for processing sensor files according to an aspect of the invention.

### DETAILED DESCRIPTION OF VARIOUS EMBODIMENTS

In an aspect is a method for determining driver behavior comprising: recording, by an in-vehicle sensor, a subject driver maneuver data and tagging the subject driver maneuver data with subject metadata comprising a subject time stamp and subject location stamp; retrieving from a driver maneuver database relevant historical driver maneuver data, the relevant historical driver maneuver data comprising tagged historical metadata comprising a historical location stamp that corresponds within a threshold distance to the subject location stamp; calculating a single-incident driver score by scaling the subject driver maneuver data according to the relevant historical driver maneuver data and tagged historical metadata; updating an aggregate subject driver score based on the single-incident driver incident score; and establishing a communication link with an automated insurance premium system and communicating the updated aggregate subject driver score to the automated insurance premium system.

In an aspect is a system that determines and monitors driver behavior comprising: an in-vehicle device configured to obtain subject driver maneuver data by selectively polling at least one in-vehicle sensor at a predetermined interval or upon a maneuver event, wherein the subject driver maneuver data is tagged with metadata comprising a subject location stamp and a subject time stamp; a processor coupled to a memory and a wireless network and configured to store the subject driver maneuver data in the memory along with relationship data that links the subject driver maneuver data to a vehicle identifier; a wireless transceiver configured to transmit the relationship data and subject driver maneuver data through a mobile communication network that provides access to a distributed network; a receiver configured to receive the relationship data and the subject driver maneuver data via the distributed network; and a processor coupled to the receiver and programmed to calculate a single-incident driver score by scaling the subject driver maneuver data according to relevant historical driver maneuver data and historical metadata corresponding to the relevant historical driver maneuver data, the relevant historical driver maneuver data correlating to the subject location, wherein the processor is further programmed to update an aggregate subject driver score based on the calculated single-incident driver score, and wherein the processor is further programmed to generate and transmit across the distributed network an alert based on the single-incident driver score or the aggregate subject driver score.

In an aspect is a method for determining and monitoring driver behavior comprising: obtaining, via an in-vehicle device, subject driver maneuver data by selectively polling a least one in-vehicle sensor at a predetermined interval or upon a maneuver event, wherein the subject driver maneuver data is tagged with metadata comprising a subject location stamp and a subject time stamp; storing, via a processor, the subject driver maneuver data and relationship data in an in-vehicle memory, wherein the relationship data links the subject driver maneuver data to a vehicle identifier and a wireless network; transmitting, via a wireless transceiver, the relationship data and subject driver maneuver data through a mobile communication network that provides access to a distributed network; receiving, via a receiver, the relationship data and the subject driver maneuver data via the distributed network; calculating, via a processor coupled to the receiver, a single-incident driver score by scaling the subject driver maneuver data according to relevant historical driver maneuver data, wherein the relevant historical driver maneuver data is selected from a driver maneuver database and correlates to the subject location, and wherein the processor is further programmed to update an aggregate subject driver score based on the single-incident driver score; and generating and transmitting across the distributed network an alert based on the single-incident driver score or the aggregate subject driver score.

In an aspect is a system configured to carry out any of the methods above and herein. The system comprises a processor and a memory coupled to the processor, the memory configured to store program instructions for instructing the processor to carry out such methods.

Further details and embodiments of the above methods and systems (and others described herein) are now described although it will be understood that such description is merely representative and is not necessarily meant to be limiting unless indicated otherwise. Variations of such embodiments within the normal skill in the art, even where not explicitly disclosed, are intended to be part of the invention. Furthermore, certain standard components and method steps may be omitted for the sake of brevity, but such components and steps are considered well within the skill in the art and are thus not necessary to disclose herein. Determination of certain suitable components and method variables may be required and, in some cases, not described herein, but such determinations are considered well within the skill in the art and would require nothing more than routine experimentation.

The methods and systems involve in-vehicle devices and in-vehicle sensors. By “in-vehicle” is meant that the device or sensor is positioned in or on the vehicle. In the case of sensors, an in-vehicle sensor is positioned and configured such that the sensor can obtain real-time information about the movement, position, or other data about a vehicle. Sensors may be positioned within the passenger compartment, within the engine compartment, within a wheel well, within a storage compartment, on a body panel (interior or exterior), or combinations thereof. The sensor may be a mobile sensor, placed in the vehicle specifically by the user to take readings, or may be a fixed sensor, such as factory-installed sensors. In the case of devices, an in-vehicle device is positioned and configured such that it can receive sensor readings from the in-vehicle sensors. An in-vehicle sensor may be a component of the in-vehicle device, in which case the device is also configured and positioned as necessary for the sensor to take readings. The device may be a mobile device, in which case it is not integrated into the vehicle. Examples include cellular devices (mobile phones), tablets, dedicated devices, and the like. The device may be non-mobile—i.e., fixed and integrated into the vehicle. Such devices typically receive power from the vehicle's power system and may further be integrated into communications and/or sensors that are also fixed into the vehicle. For example the device may receive GPS data, terrain data, wheel alignment data, or other types of data from on-board fixed vehicle sensors (e.g., sensors that are factory-installed).

Examples of in-vehicle sensors include telematics sensor devices. Examples include GPS sensors for obtaining Global Positioning System coordinates of the vehicle, On-Board Diagnostics such as ODB-II devices and systems, and/or kinetic sensors such as gyroscopes, accelerometers, and the like. An alternative or supplementing method for determining the coordinates of the vehicle and/or sensor is via triangulation of a plurality of cellular signals from fixed cellular transceivers.

A plurality of in-vehicle sensors (in any combination of the above or other sensors) may be present and may provide data, each in the form of a data file or in the form of a real-time data stream. For example, 2, 3, 4, 5, or more than 5 sensors may be present (in any combination of integrated with the in-vehicle device and integrated with the vehicle) and used in the methods herein.

The in-vehicle sensors record data (also referred to herein as subject data or subject driver data) about the movement, position, and actions of the vehicle. Movement of the vehicle includes direction and speed, as well as changes thereof (acceleration, deceleration, swerving, etc.). Position of the vehicle is, typically, coordinate-based although may in embodiments be relative position to a known/fixed location. Position of the vehicle may also include the orientation of the vehicle. Actions of the vehicle include activation of the anti-lock braking system, actions of the vehicle's suspension, and the like. In embodiments, these data are recorded in data files and transmitted to the in-vehicle device, particularly where the in-vehicle sensors and the in-vehicle device are separate components. In other embodiments the data files are directly transmitted to a remote server, such as where the in-vehicle sensors are integrated into the vehicle and coupled to a communications module for communicating with a distributed network. The subject driver data is the data from which subject driver maneuver data is identified as described herein in more detail. Data may be obtained and stored continuously, or at regular intervals (e.g., instantaneously every 1, 2, 3, 4, or 5 seconds, or for 1 second every period of 5 or 10 seconds, or the like), or when the in-vehicle sensor registers a change in any sensor reading, or some combination thereof. Sensing of data and recording/storing of data may occur at different intervals. For example, the sensors may be continuously sensing data but recording only periodically or when an unexpected sensor reading is obtained.

In embodiments, an in-vehicle device comprises at least one integrated in-vehicle sensor, and may comprise 2, 3, 4, 5 or more sensors. The in-vehicle device may further comprise a processor coupled to a memory, and a communications module configured to form a communications link to communicate data via a distributed network. In embodiments the communications link (whether used by the in-vehicle device or a communications module in the vehicle coupled to integrated in-vehicle sensors) is established via a wireless network, comprises a medium selected from RF, Bluetooth, infrared, or WiFi, or any other medium now known or later developed provided that the medium is suitable. The wireless communications involve a wireless transceiver associated with the in-vehicle sensor and/or in-vehicle device. In embodiments involving a server, the server comprises a receiver configured to receive the data from the in-vehicle device/sensors. In embodiments, the communication link may be established when the vehicle is stationary, such as when the vehicle returns to a home-base device or the like. In such cases bulk transmission of stored data files may be required. In embodiments, the communications link is established and maintained as the vehicle is mobile, thereby allowing a live stream of communications to occur between the in-vehicle device and a remote server. In embodiments and as described herein in more detail, the in-vehicle device is configured to obtain subject driver maneuver data by selectively polling a plurality of in-vehicle sensors.

In embodiments, the wireless transceiver associated with the in-vehicle device and/or in-vehicle sensor(s) is further configured to encrypt the relationship data (i.e., any recorded metadata) and the subject driver maneuver data prior to transmitting such data by the wireless network. The receiver at the server, then, is configured to decrypt the encrypted data. In embodiments, the wireless transceiver comprises a single-chip cellular baseband processor, where the single-chip cellular baseband processor comprises integrated interface drivers that enable auxiliary components comprising loudspeakers, display, and memory modules to connect directly to the single-chip.

The subject data is obtained by the in-vehicle device and optionally communicated to a server, and then is analysed by a maneuver detection system (MDS). The MDS may be local to an in-vehicle device, or may be remotely located on a server, or some combination thereof. The MDS analyses subject data to identify subject driver maneuver data. Subject driver maneuver data is data for a vehicle's actions as it maneuvers in response to a road hazard. Road hazards include potholes, speed bumps, pedestrian crossings, barriers, trenches, pushcarts, motorcycles, animals, and other moving objects, among other possible hazards. For example, a vehicle may swerve to avoid a pothole, brake unusually hard when encountering a speed bump or other object in the road, or swerve and brake when encountering a pedestrian. Such behaviour can often be observed in data from the in-vehicle sensors (e.g., acceleration, deceleration, swerving, sharp turns, impact from potholes, etc.), and the MDS is configured to recognize the patterns in the data that indicate such behaviour. Subject driver maneuver data may also be vehicle actions that fail to respond to a road hazard. For example, a vehicle that traverses a known speed bump without changing speed indicates that the driver did not see or anticipate the speed bump, and such failure to act may also be considered subject driver maneuver data.

As described, the MDS may reside locally on the in-vehicle device or remotely on the server, or both. In order to assist the MDS with identifying subject driver maneuver data from subject data, the systems herein may store a database of model maneuver data. Model maneuver data includes optimized and/or raw data from one or a variety of sources that are known to represent common maneuvers. For example, model maneuver data may include data indicative of harsh braking, swerving, or the like, in order to provide reference data against which the MDS can compare raw data from in-vehicle sensors. The model maneuver data can be categorized by vehicle type (e.g., large 4-wheel drive sport utility vehicles, small 2-wheel drive saloon cars, etc.), driver type (e.g., aggressive driver, passive driver, etc.), or otherwise as desired.

In embodiments, data and data files obtained by the in-vehicle sensors are tagged with subject metadata. Metadata provides context for the recorded data, and a wide variety of metadata may be obtained. Examples of subject metadata include a subject time stamp (such as obtained from an integrated clock or from a GPS signal or some other source), a subject location stamp (as provide by a GPS signal or determined from a plurality of cellular signals, although a subject location stamp may alternatively be primary sensor data rather than or in addition to metadata), weather data (such as obtained indirectly from a weather report, or directly from a sensor such as a barometric pressure sensor or humidity sensor or the like), seasonal data (e.g., rainy season v. dry season), road hazard data (e.g., as determined by camera or other data, or as appended by the system from a road hazard map, as described in more detail herein), moving hazard data, and/or population density data (e.g., as determined by proximity sensors on a vehicle or by historical data or census data). The metadata just described is also referred to herein as subject metadata, such as subject time stamp, subject location stamp, subject weather report, and the like. All such data may be referred to herein as contextual data, as it provides context to the driver maneuver data. Certain of such data may affect large areas that include the subject location as well as, potentially, many adjacent locations. For example, a subject weather report may encompass the subject location and up to several kilometres in any direction from that location. For such metadata, the subject location should be within a threshold distance from the location that is relevant to the contextual data. The threshold value may be predetermined and may vary depending on the type of variable and the context—for example, a threshold distance for a weather report is likely to be larger (e.g., between 1-1000 m) compared with a threshold distance for a road hazard (e.g., between 1-10 m).

Other metadata may be associated with the data file(s), such as a road segment ID, particularly after the subject data is cross-referenced to a location on a road hazard map, as described in more detail herein. A road segment identification (ID) is a label applied to a specific section of roadway, which segment may be any preferable length but is typically within the range of 5-1000, 10-500, or 10-200 m in length, or is less than or equal to 1000, 800, 500, 300, 200, 100, 50, 30, or 20 m in length, or is greater than or equal to 5, 10, 20, 25, 30, 50, 100, 200, 300, 500, or 800 m in length. In embodiments road segments corresponding to individual road segment IDs are not uniform in length, but may vary based on a number of factors such as the population density, zoning usage (e.g., commercial or residential), accident frequency, and the like, or combinations thereof. The road segment IDs may include or be associated with a coordinate or other geo-locator. For example, the coordinate may be that of the centre point along the length of the road segment. Alternatively a road segment ID may be associated with two coordinates—one corresponding to a beginning of the segment and one corresponding to an end of the road segment. In embodiments, coordinates may be used directly as a road segment ID. Other methods of identifying the road segment are known and suitable. In embodiments, the subject location stamp that is metadata (or primary sensor data) can be the road segment ID, or can be coordinate data that is then converted to a road segment ID. In embodiments, the systems involve a hash module that converts coordinates to a road segment ID. Thus, a data file submitted by an in-vehicle sensor and containing a GPS coordinates can be mapped to the specific road segment ID corresponding to the road segment where the data file was obtained.

The systems and methods involve building and storing a road hazard map (RHM). In embodiments of the road hazard map, road segment IDs are used. The RHM may be created (in whole or in part) separately and input to the systems herein. Alternatively or in addition, the RHM may be constructed based on sensor data obtained from the in-vehicle devices. Alternatively or in addition, the system may include a mode whereby test vehicles collect data specifically to form the RHM (e.g., vehicles and drivers traverse road segments and identify hazards, tagging such hazards with labels and coordinates). Road hazards may be identified, and their identity refined, based on driver behaviour and sensor data obtained by in-vehicle sensors. For example, a speed bump may be identified and labelled as such in the RHM where the system observes a large number of sensor data showing vehicles slow at a specific point in a road segment without a corresponding swerve (since a corresponding swerve might alternatively indicate a pothole rather than a speed bump). These and other methods may be used to construct the RHM. The RHM may be stored locally in memory of an in-vehicle device and/or may be stored remotely in a server memory. Where local versions of the RHM are maintained, the systems can include methods for automatic updates of the locally stored RHM when new data is available (both continuous updates and periodic updates are possible, depending on the connectivity of the in-vehicle devices).

As mentioned previously, the system can further tag subject data with further contextual data such as road hazard data. For example, from the RHM, the system can tag subject data with a road hazard located at or within a threshold distance from the coordinates tagged to the subject data. For example, when an in-vehicle device transmits to the server subject data for a specific road segment ID, and the server identifies (from the RHM) a road hazard within the same road segment ID, the subject data may be tagged with that road hazard as metadata. If individual road segments are large, it may be necessary for the system to check the specific coordinates of the data and of the road hazard. The road hazard should be within a threshold distance from the subject data, which threshold distance can be fixed or can vary according to any appropriate variable (e.g., type of hazard). The threshold can be within the range of 1-10, or 1-5, or 1-3 m or less than or equal to 10, 8, 5, 3, or 2 m. Any road hazard within the threshold distance may be referred to herein as a “relevant” road hazard.

In embodiments, a data file comprises data corresponding to a single maneuver. For example, the in-vehicle sensor may detect behaviour indicative of a maneuver (e.g., abnormally hard braking), and may record/store the data pertaining to that maneuver (e.g., for a second or portion of a second before the indicative behaviour until a second or several seconds after) into a data file. Alternatively, a data file may comprise data corresponding to a specific length of time, and one or a plurality of maneuvers may be recorded within the data file. In such cases the data file may also contain data from periods where the vehicle is not maneuvering, and the MDS will analyse the whole of the data file to identify maneuvers from the data.

In embodiments and as mentioned, the server (or in-vehicle device) receives a data file and the MDS identifies a maneuver (or a plurality of maneuvers) in the data. The identified maneuvers are intended to be compared with historical maneuvers at similar locations or under similar context as mentioned herein, so the MDS may isolate the data that pertains to a maneuver from data that describes normal operations of the vehicle (i.e., is not related to the maneuver). For example, in a situation of harsh braking, the MDS may isolate a period extending from one second or a fraction of a second prior to the braking, through one second or more than one second after the period of harsh breaking. In embodiments, the MDS may compare the subject driver maneuver data to model maneuver data and create a timeline of maneuver events, each event being represented by a label (e.g., “harsh braking”, “swerve”, etc.) and each event remaining associated with the metadata that labelled the original data. The event may also include an objective magnitude label (e.g., “extreme”, “moderate”, etc.) supplied by the MDS based on the comparison with model maneuver data. The event label, magnitude label, and associated metadata may then be passed to the driver score module (DSM) as described herein. Alternatively, the MDS may pass the raw data pertaining to the maneuver event along with the associated metadata to the DSM as described herein.

In embodiments, the DSM is configured to compare subject driver maneuver data and accompanying metadata to historical maneuver data and historical metadata (both stored and obtained from a driver maneuver database, described below), and from that comparison to generate a single-incident driver score, as described in more detail herein.

The systems herein maintain a driver maneuver database (also referred to herein as a context driver behaviour database). The driver maneuver database may be stored locally on the in-vehicle device or remotely on the server, or a combination thereof. Where local versions of the driver maneuver database are maintained, the systems can include methods for automatic updates of the locally stored driver maneuver database when new data is available (both continuous updates and periodic updates are possible, depending on the connectivity of the in-vehicle devices). The driver maneuver database comprises historical driver maneuver data and associated historical metadata. Such data and metadata may be conveniently organized by location (e.g., road segment ID and/or coordinates) and/or by maneuver type, and/or by some other convenient method of organization. In embodiments, the historical driver maneuver data comprises data files previously obtained from in-vehicle sensors and devices (i.e., not from the subject driver, not subject driver data) disposed in vehicles that previously traversed the same or similar road segment and encountered the same or similar road hazard. Thus, the driver maneuver database represents prior driver reactions to the same or similar road hazard, and potentially under a variety of contextual conditions. For example, given a specific road hazard such as a speed bump in a specific road segment ID, over time a plurality of drivers will encounter the speed bump and maneuver (or not maneuver) during the encounter. Some maneuvers may involve harsh braking, whereas other maneuvers may involve gradual braking and still others may involve no braking at all. Certain such maneuvers will be most common, whereas others will be less and least common. Each historical maneuver will have associated contextual information. For example, the historical time stamps of such historical maneuvers will indicate whether an encounter was during the daytime or night time, and the maneuvers may be different at different times (e.g., due to lighting, heavy traffic on the road, etc.). The historical weather reports of such historical maneuvers will indicate whether weather is an important factor in the type of maneuver(s) that is common for the specific hazard.

In embodiments, for the DSM to make a comparison and compute a single-incident driver score, the system identifies historical maneuver data within a threshold distance from the subject location stamp of the subject driver maneuver data. As mentioned elsewhere, the threshold distance may be within the same road segment (or, where road segments are very small or very close in space, an adjacent road segment), or greater or smaller, such as within a specific distance. Example distances include within the range 1-10, or 1-5, or 1-3 m or less than or equal to 10, 8, 5, 3, or 2 m. The threshold distance is configured so as to provide a high likelihood that subject maneuver data and the historical maneuver data are related to the same road hazard. Any historical maneuver data (and the associated metadata) that is/are within the threshold distance of the subject maneuver data is/are referred to herein as “relevant” historical maneuver data. It should be noted that, for purposes of identifying relevant historical data, the distance between the subject location stamp and the historical data can be measured either to the location of the road hazard associated with the historical data or to the specific historical location (i.e., the historical location stamp of specific historical data). It will be appreciated that, in embodiments, the driver maneuver database may be updated with the subject driver maneuver data once it is received and processed. In this way the driver maneuver database can continue to grow over time, and the accuracy of locations, the scope of driver maneuvers, and the breadth of contextual information can continue to improve over time and use of the system.

As mentioned, the DSM computes a single-incident driver score by comparing driver maneuver data with historical maneuver data. The single-incident driver score is a performance score that is weighted within driving context (e.g., harshbreaks, swerving, sharp turns, acceleration, etc.) and accounts for other drivers' performance in a clustered context. An example method for calculating single-incident driver score is provided herein below, and variations of the same may be used as appropriate. The weighting may be based solely on historical maneuver data (i.e., what other drivers did in a similar context, at the same location, etc.) or may further account for factors from the subject metadata, such as the subject weather report and the like. Furthermore, in embodiments, the single-incident driver score is in part determined by relevant road hazards, the relevant road hazards determined by receiving, by the processor, road hazard locations from the RHM, and correlating the location of road hazards to the subject location. The DSM aggregates all relevant metadata, historical maneuver data, and historical metadata (determining relevancy as appropriate, such as by physical proximity to the subject location stamp or such as situational similarity) and uses such information to calculate the single-incident driver score for the subject maneuver.

The single-incident driver score can be data that is also stored in the driver maneuver database, for example as an indication about driver behaviour towards a particular road hazard. In such instances, once the single-incident driver score for a subject driver is calculated by a DSM, the score can be communicated to the driver maneuver database and the database updated based on the score.

The single-incident driver score can be used singly, or in embodiments can be used to update an aggregate subject driver score. The aggregate subject driver score is a score that is specific to the subject driver and is an aggregation of the subject driver's behaviour over a period of time and/or with respect to a plurality of road hazards encountered by the subject driver. The aggregate subject driver score can be calculated in a variety of ways, such as averaging (weighted or un-weighted) the single-incident driver scores for a subject driver. The aggregate subject driver score is configured to provide a more accurate indication of the overall driving skill and/or riskiness of the subject driver, since it is an aggregate score and since each factor contributing to the aggregate score factors context into the calculation of the score.

The single-incident driver score and aggregate subject driver score are information that can be used in a variety of ways as described herein. In embodiments, determination of either score can initiate a system according to the invention (either an in-vehicle device or a server) to automatically establish a communications channel via a distributed network with another entity. The other entity can be a server according to the invention (in the case of an in-vehicle device establishing the communications channel) or can be an entity apart from the systems of the invention. Such separate entities can be specifically relevant to the subject driver and/or relevant to drivers and road users generally. Examples of such separate entities include insurance providers, road maintenance authorities, and the like. Communications with such entities can be carried out automatically via a suitable distributed network and suitable communications modules in the server/devices of the invention. Such communications can be configured to automatically initiate a variety of responses and reactions. More specific examples of such communications and responses are provided below.

The single-incident driver score can be used in a variety of ways by the systems herein. For example, in embodiment, the single-incident driver score can be communicated to a server to update a driver maneuver database. The single-incident driver score can be communicated to an in-vehicle device to cause the device to alert the subject driver of erratic or unsafe or risky behaviour, such as with an automatic audible or visual alert (e.g., a heads up display or other display in a vehicle can be altered to provide the alert).

The aggregate subject driver score can be used in a variety of ways by the systems herein. In an embodiment, the score can be communicated in a message configured cause the automated insurance premium system to automatically alter an insurance product based on the updated subject driver score. In embodiments, the aggregate subject driver score can be communicated via an automatic alert generated by the system, the alert configured to initiate any or all of the following: an insurance system in communication via a distributed network to update an insurance premium for the driver; a route recommendation system to alter a route recommendation; a route recommendation system to find a route that will least likely impact driver scores, e.g., because a route does not have a lot of maneuvers for the given context, and communicate that route recommendation to the subject driver and/or to an in-vehicle device; a route recommendation system to determine a route least likely to impact a driver score; and a road maintenance authority to initiate a needed road repair at the subject location. For example, based on the aggregate subject driver score communicated via a message from a server of the invention, an insurance system can automatically revise an insurance package and/or premium applied to the subject driver. The automatic adjustment can be further automatically communicated to the subject driver via electronic or physical mail or messaging. Any of the foregoing actions can involve modification of a graphical user interface (GUI) or other interface or I/O device in order to carry out the action and/or communicate the action to a user. For example, a GUI associated with a route recommendation system in one or more in-vehicle devices can be modified upon receiving an alert generated from the server and communicated via a distributed network, the alert generated based on the instantaneous location of the in-vehicle device (e.g., as measured by GPS sensor or other means) and based on relevant historical maneuver data pertaining to road hazards in proximity to the instantaneous location. In embodiments the alert can be configured to display an alert or to modify the behaviour of an autonomous vehicle control system.

Apart from the single-incident and aggregate driver scores, other information collected and generated by the systems herein find a variety of uses. In embodiments the system can be configured to communicate all or a portion of the driver maneuver database to an automated system configured to initiate a repair of a road segment based on the contents of the driver maneuver database. In embodiments the system can be configured to automatically generate and communicate an alert to an in-vehicle device based on the presence of a road hazard identified in the road hazard map and in proximity (e.g., within 1-50 or 1-20 m, or within the same or an adjacent road segment ID) to the subject location stamp.

An embodiment of the calculations for a context-based single-incident driver score is as follows. The score is weighted by data from other drivers indicating their maneuvers in the same context. An example for this weighting is provided by the equation:

$${f}_{c} ( d , x ) = {\sum }_{x ∈ {X}_{d}^{m , ID}} 1 - P ( x \vert context ( x ) ) , m = {m}_{i}$$

This equation shows the sum of all maneuvers x, executed by driver d, weighted by the driving context. Driving context is determined from the driver behavior of all other drivers in the same context, for example using the equation:

$$S ( d , {m}_{i} ) = \frac{1}{1 + \frac{{f}_{c} ( d , {m}_{i} )}{avg ( {f}_{c} ( D , {m}_{i} ) )}}$$

where the overall driver score is for driver d and all maneuvers of type mᵢ in their given context c. In embodiments the method weights with a predefined weight on Wᵢ such as with the following equation:

$$S ( d ) = \frac{{\sum }_{i = 1}^{n} {W}_{i} S ( d , {m}_{i} )}{{\sum }_{i = 1}^{n} {W}_{i}} , n = \vert M \vert$$

where this is an example calculation for the overall subject driver score, in which represents the score for a driver S(d), all the maneuvers that the driver executed, M, where n is the total number of maneuvers, and the contexts associated with each of those maneuvers, c.

The invention includes systems configured to carry out any of the methods described herein, such systems including system components necessary to carry out such methods. Such systems may comprise, as appropriate, one or more processor coupled to one or more memory, the memory storing machine-readable instructions suitable to instruct the processor(s) to carry out the desired method. As mentioned, the systems herein are described with sufficient detail such that one of ordinary skill can, from the disclosure and known art, make and use such systems, even though some standardized components may not be explicitly described herein.

Various embodiments of the invention are described more fully hereinafter with reference to the accompanying drawings. The invention herein may be embodied in many different forms and should not be construed as limited to the embodiments set forth in the drawings; rather, these embodiments are provided to provide further illustrative non-limiting examples. Arrowheads in the figures are provided merely as examples of directions for the flow of data but are not exhaustive and are not meant to be limiting—i.e., data may flow (where appropriate) in directions that are not shown by arrowheads in the figures. Similar numbers in different figures are meant to refer to similar components.

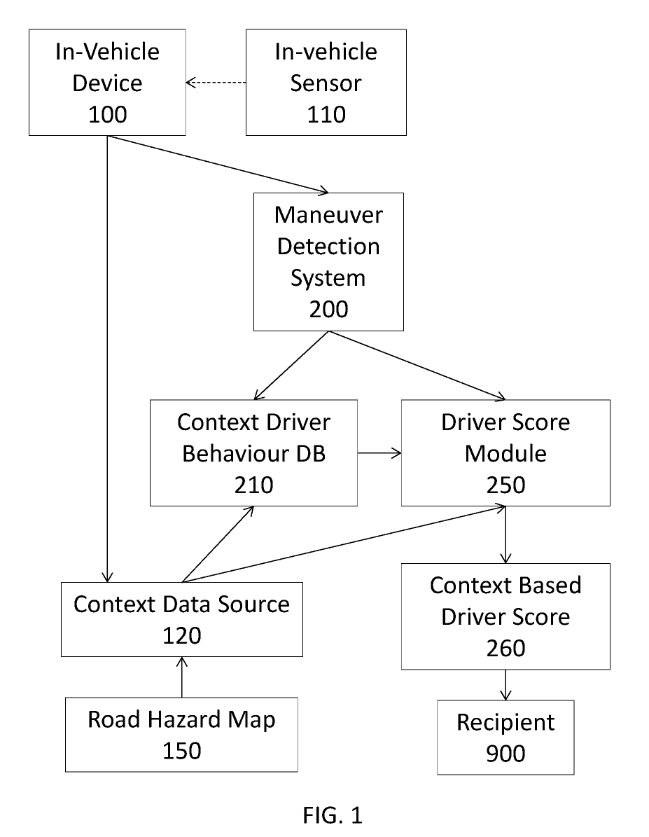

With reference to FIG. 1, there is shown a flow chart for recording data, processing the data, and communicating the data to recipients according to an embodiment of the invention. Sensor data is recorded by in-vehicle sensor 110, and the sensor data is optionally relayed to in-vehicle device 100. The relay is optional because in-vehicle sensor 110 may be an integrated component of in-vehicle device 100, in which case such relay is not necessary, or may be a separate device/component in which case the relay is required. The activities that occur after recording sensor data and (optionally) communicating the data to in-vehicle device 100 may be carried out locally within in-vehicle device 100, or may be carried out remotely such as by a server (not shown), or a combination thereof as appropriate. The sensor data may include GPS coordinates from a GPS sensor (not shown) as well as telekinetic data from telekinetic sensors (not shown). The sensor data is labeled with context variables from (one or more) context data source 120—e.g., metadata such as a timestamp, weather conditions, automatic detection and geo-location of relevant (i.e., proximate) road hazards from road hazard map 150, and the like. The sensor data is processed by maneuver detection system 200 in order to detect maneuvers from the raw sensor data. The detected maneuvers and the metadata are compared to context based driver behavior database 210 and then driver score module 250 computes context based driver score 260. The driver score is communicated to recipient 900 (e.g., an insurance company or the like).

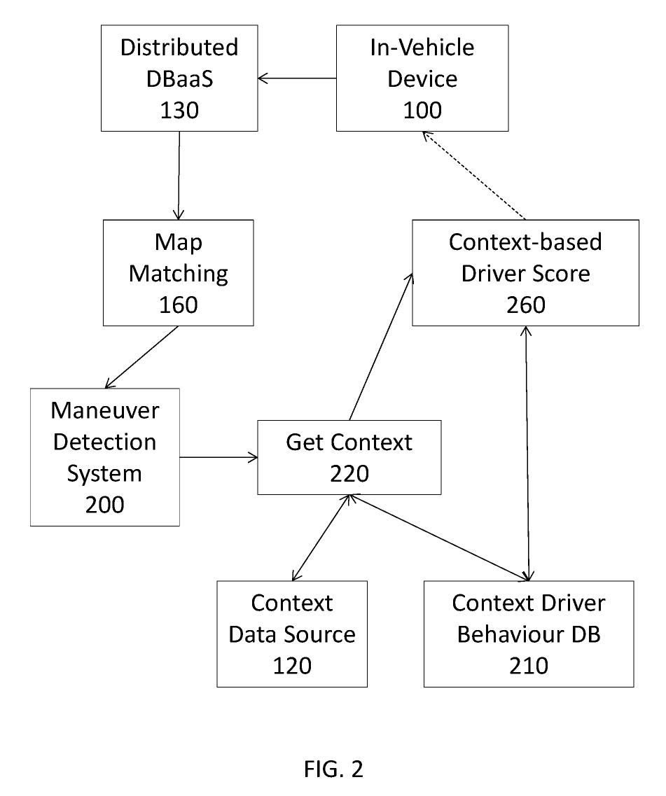

With reference to FIG. 2, in-vehicle device 100 records data and creates a sensor file (not shown). The sensor file is communicated to a database, such as Distributed DBaaS (Database as a Service) 130. The GPS coordinates associated with the collected data are matched via map matching module 160. Driver behavior is detected using maneuver detection system 200. With the resulting driver behavior and metadata, the system retrieves contextual information 220 from (one or more) context data source 120 as well as context-based driver behavior from context driver behavior table 210. With the resulting driver behavior, metadata, and context data, the driver score module (not shown) computes context-based driver score 260. The score is communicated to the context driver behavior database 210 in order to update the table, is optionally communicated to the in-vehicle device, and is also communicated to other users such as insurance providers and road monitoring entities (not shown).

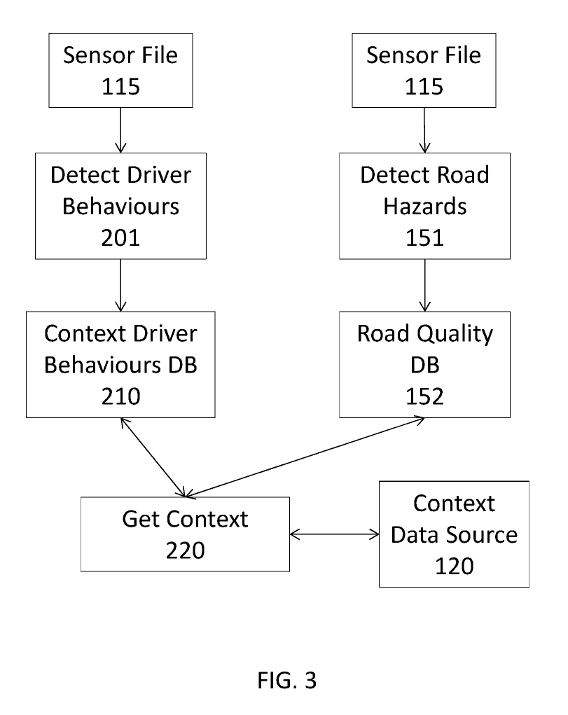

With reference to FIG. 3, sensor file 115 is obtained and produced by an in-vehicle sensor and/or in-vehicle device (not shown). The file is analyzed (e.g., by a maneuver detection system, not shown) to detect driver behavior 201 and the resulting identified behavior is cross-referenced to context driver behavior DB 210. Furthermore with sensor file 115, the system uses a road hazard map (not shown) to detect road hazards 151 and road quality from road quality DB 152, a part of the road hazard map. The data is used and contextual information is obtained 220 from at least one context data source 120.

Throughout this disclosure, use of the term “server” is meant to include any computer system containing a processor and memory, and capable of containing or accessing computer instructions suitable for instructing the processor to carry out any desired steps. The server may be a traditional server, a desktop computer, a laptop, or in some cases and where appropriate, a tablet or mobile phone. The server may also be a virtual server, wherein the processor and memory are cloud-based.

The methods and devices described herein include a memory coupled to the processor. Herein, the memory is a computer-readable non-transitory storage medium or media, which may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Throughout this disclosure, use of the term “or” is inclusive and not exclusive, unless otherwise indicated expressly or by context. Therefore, herein, “A or B” means “A, B, or both,” unless expressly indicated otherwise or indicated otherwise by context. Moreover, “and” is both joint and several, unless otherwise indicated expressly or by context. Therefore, herein, “A and B” means “A and B, jointly or severally,” unless expressly indicated otherwise or indicated otherwise by context.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference. All combinations of the embodiments described herein are intended to be part of the invention, as if such combinations had been laboriously set forth in this disclosure.

### EXAMPLES

### Example 1

A simulation involved a vehicle traversing a road segment and carrying out three maneuvers (as recorded by sensors): a first maneuver of over-speeding, a second maneuver of swerving, and a third maneuver of harsh braking.

A driver incident score was calculated in two ways: the traditional way (not using the invention herein) and by a method according to an embodiment herein.

Using the traditional calculation (i.e., without contextual information), the driver incident score is calculated as the sum of all maneuvers mᵢ executed by driver d. Thus, the calculation is according to the following equation:

f(mᵢ,d)=|X_{D=d}^{M=m}^{ᵢ}^{,ID}|

In the simulated situation, three maneuvers were observed so the driver incident score is 3.

Using a method according to the invention, the simulation was repeated. Each maneuver was associated with contextual information. The first maneuver (over-speeding) was associated with the context that a speed bump was present at the same location as the maneuver. The second maneuver (swerving) was associated with the context that a pothole was present at the same location as the maneuver. The third maneuver (harsh braking) was associated with the context that a speed bump was present at the same location as the maneuver. The driver incident score was then calculated with the equation:

$${f}_{c} ( d , x ) = {\sum }_{x ∈ {X}_{d}^{m , ID}} 1 - P ( x \vert context ( x ) ) , m = {m}_{i}$$

In the simulated situation, we have conditional probabilities as the percentage of all recorded drivers executing the same maneuver in the same context:

P(over-speeding|speed bump)=0.01

P(harsh brake|speed bump)=0.3

P(swerve|pothole)=0.5

Thus, the context-based driver incident score is 2.19, with the calculation as shown here:

[1−(0.01)]+[1−(0.3)]+[1−(0.5)]=2.19

The driver incident score of 2.19 is considerably less than the score of 3.0 (obtained without reference to context).

What is claimed is:

1. A method for determining driver behavior comprising:
recording, by an in-vehicle sensor, a subject driver maneuver data and tagging the subject driver maneuver data with subject metadata comprising a subject time stamp and subject location stamp;
retrieving from a driver maneuver database relevant historical driver maneuver data, the relevant historical driver maneuver data comprising tagged historical metadata comprising a historical location stamp that corresponds within a threshold distance to the subject location stamp;
calculating a single-incident driver score by scaling the subject driver maneuver data according to the relevant historical driver maneuver data and tagged historical metadata;
updating an aggregate subject driver score based on the single-incident driver score; and
establishing a communication link with an automated insurance premium system and communicating the updated aggregate subject driver score to the automated insurance premium system.

2. The method of claim 1, wherein the subject time stamp is provided by an in-vehicle clock or a GPS signal, and wherein the subject location stamp is provided by a GPS signal or determined from a plurality of cellular signals.

3. The method of claim 1, wherein the subject maneuver data is determined from a plurality of in-vehicle sensors.

4. The method of claim 1, wherein the historical metadata further comprises contextual information selected from weather, time of day, and season.

5. The method of claim 1, wherein the updated aggregate subject driver score is in a message configured to cause the automated insurance premium system to automatically alter an insurance product based on the updated subject driver score.

6. The method of claim 1, wherein the driver maneuver database is stored and maintained remotely on a remote server, wherein the remote server is configured to receive subject driver maneuver data and subject metadata.

7. The method of claim 1, further comprising updating the driver maneuver database based on the subject driver maneuver data and subject metadata.

8. The method of claim 1, wherein the tagged historical metadata further comprises a historical weather report, and wherein the method further comprises obtaining a subject weather report corresponding to the subject location stamp and adding the subject weather report to the subject metadata.

9. The method of claim 1, comprising adding a subject weather report to the subject metadata, the subject weather report corresponding within a threshold distance to the subject time stamp and subject location stamp, and further comprising using the subject weather report in calculating the single-incident driver score.

10. A system comprising:
a processor;
a memory coupled to the processor, the memory configured to store program instructions for instructing the processor to carry out a method for determining driver behavior comprising:
recording, by an in-vehicle sensor, a subject driver maneuver data and tagging the subject driver maneuver data with subject metadata comprising a subject time stamp and subject location stamp;
retrieving from a driver maneuver database relevant historical driver maneuver data, the relevant historical driver maneuver data comprising tagged historical metadata comprising a historical location stamp that corresponds within a threshold distance to the subject location stamp;
calculating a single-incident driver score by scaling the subject driver maneuver data according to the relevant historical driver maneuver data and tagged historical metadata;
updating an aggregate subject driver score based on the single-incident driver score; and
establishing a communication link with an automated insurance premium system and communicating the updated aggregate subject driver score to the automated insurance premium system.

11. A system that determines and monitors driver behavior comprising:
an in-vehicle device configured to obtain subject driver maneuver data by selectively polling at least one in-vehicle sensor at a predetermined interval or upon a maneuver event, wherein the subject driver maneuver data is tagged with metadata comprising a subject location stamp and a subject time stamp;
a processor coupled to a memory and a wireless network and configured to store the subject driver maneuver data in the memory along with relationship data that links the subject driver maneuver data to a vehicle identifier;
a wireless transceiver configured to transmit the relationship data and subject driver maneuver data through a mobile communication network that provides access to a distributed network;
a receiver configured to receive the relationship data and the subject driver maneuver data via the distributed network; and
a processor coupled to the receiver and programmed to calculate a single-incident driver score by scaling the subject driver maneuver data according to relevant historical driver maneuver data and historical metadata corresponding to the relevant historical driver maneuver data, the relevant historical driver maneuver data correlating to the subject location,
wherein the processor is further programmed to update an aggregate subject driver score based on the calculated single-incident driver score, and
wherein the processor is further programmed to generate and transmit across the distributed network an alert based on the single-incident driver score or the aggregate subject driver score.

12. The system of claim 11, where the wireless transceiver comprises a single-chip cellular baseband processor, where the single-chip cellular baseband processor comprises integrated interface drivers that enable auxiliary components comprising loudspeakers, display, and memory modules to connect directly to the single-chip.

13. The system of claim 11, wherein the relevant historical driver maneuver data is obtained from a driver maneuver database comprising historical driver maneuver data and tagged historical metadata, the historical metadata comprising a time stamp and a location stamp.

14. The system of claim 11, wherein the single-incident driver score is further determined by relevant road hazards, the relevant road hazards determined by receiving, by the processor, road hazard locations from a road hazard map, and correlating the location of road hazards to the subject location.

15. The system of claim 11, wherein the alert is configured to cause one or more actions selected from: an insurance system on the distributed network to update an insurance premium for the driver; a route recommendation system to alter a route recommendation; a route recommendation system to determine a route least likely to impact a driver score; and a road maintenance authority to initiate a needed road repair at the subject location.

16. The system of claim 11, wherein the processor is further configured to obtain a context data pertaining to the subject driver maneuver data and use the context data in calculating the single-incident driver score.

17. The system of claim 11, wherein the relevant historical driver maneuver data is contained within a driver maneuver database coupled to the processor.

18. The system of claim 11, wherein the relevant historical driver maneuver data is contained within a driver maneuver database coupled to the processor, and wherein the processor is further configured to update the driver maneuver database based on the calculated single-incident driver score.

19. A method for determining and monitoring driver behavior comprising:
obtaining, via an in-vehicle device, subject driver maneuver data by selectively polling a least one in-vehicle sensor at a predetermined interval or upon a maneuver event, wherein the subject driver maneuver data is tagged with metadata comprising a subject location stamp and a subject time stamp;
storing, via a processor, the subject driver maneuver data and relationship data in an in-vehicle memory, wherein the relationship data links the subject driver maneuver data to a vehicle identifier and a wireless network;
transmitting, via a wireless transceiver, the relationship data and subject driver maneuver data through a mobile communication network that provides access to a distributed network;
receiving, via a receiver, the relationship data and the subject driver maneuver data via the distributed network;
calculating, via a processor coupled to the receiver, a single-incident driver score by scaling the subject driver maneuver data according to relevant historical driver maneuver data, wherein the relevant historical driver maneuver data is selected from a driver maneuver database and correlates to the subject location, and wherein the processor is further programmed to update an aggregate subject driver score based on the single-incident driver score; and
generating and transmitting across the distributed network an alert based on the single-incident driver score or the aggregate subject driver score.

20. A system comprising:
a processor;
a memory coupled to the processor, the memory configured to store program instructions for instructing the processor to carry out a method for determining and monitoring driver behavior comprising:
obtaining, via an in-vehicle device, subject driver maneuver data by selectively polling a least one in-vehicle sensor at a predetermined interval or upon a maneuver event, wherein the subject driver maneuver data is tagged with metadata comprising a subject location stamp and a subject time stamp;
storing, via a processor, the subject driver maneuver data and relationship data in an in-vehicle memory, wherein the relationship data links the subject driver maneuver data to a vehicle identifier and a wireless network;
transmitting, via a wireless transceiver, the relationship data and subject driver maneuver data through a mobile communication network that provides access to a distributed network;
receiving, via a receiver, the relationship data and the subject driver maneuver data via the distributed network;
calculating, via a processor coupled to the receiver, a single-incident driver score by scaling the subject driver maneuver data according to relevant historical driver maneuver data, wherein the relevant historical driver maneuver data is selected from a driver maneuver database and correlates to the subject location, and wherein the processor is further programmed to update an aggregate subject driver score based on the single-incident driver score; and
generating and transmitting across the distributed network an alert based on the single-incident driver score or the aggregate subject driver score.
